(19) United States
(12) Patent Application Publication
(10) Pub. No.: US 2026/0201844 A1
(43) Pub. Date: Jul. 16, 2026

(54) GAS TURBINE START CONTROL DEVICE

(71) Applicant: MITSUBISHI HEAVY INDUSTRIES, LTD., Tokyo (JP)

(72) Inventors: Kengo OKAMOTO, Tokyo (JP); Yoshifumi IWASAKI, Tokyo (JP); Hidehiko NISHIMURA, Tokyo (JP); Teruhiro MATSUMOTO, Tokyo (JP); Kuniharu FUJIBAYASHI, Tokyo (JP); Kentaro SUZUKI, Tokyo (JP); Ryusuke KUBOYAMA, Tokyo (JP); Yasuhiro NIINA, Tokyo (JP)

(21) Appl. No.: 19/135,235

(22) PCT Filed: Dec. 8, 2023
(86) PCT No.: PCT/JP2023/044047

§ 371 Date: Jun. 3, 2025

(30) Foreign Application Priority Data
Dec. 20, 2022 (JP) 2022-202992

(51) Int. Cl. F02C 9/26; F02C 7/26

(52) U.S. Cl. CPC F02C 9/26; F02C 7/26; F05D 2260/85

(57) ABSTRACT

A gas turbine control device including a fuel flow rate command value calculation unit and a fuel flow rate control unit. The fuel flow rate command value calculation unit calculates a fuel flow rate command value by means of proportional integration control based on the deviation between a gas turbine rotation number and a target rotation number, or the deviation between a gas turbine output and a target output load. The fuel flow rate control unit controls the flow rate of fuel with respect to a gas turbine based on the fuel flow rate command value. The fuel flow rate command value calculation unit calculates the fuel flow rate command value so that the output of the gas turbine in a first output band increases at a first rate of change, and the output of the gas turbine in a second output band increases at a second rate of change.

### TECHNICAL FIELD

The present disclosure relates to a gas turbine startup control device.

The present application claims priority based on Japanese Patent Application No. 2022-202992 filed in Japan on Dec. 20, 2022, the contents of which are incorporated herein by reference.

### BACKGROUND ART

When a gas turbine is started, a rotation speed of the gas turbine in a stopped state is increased to a target rotation speed (for example, a rated rotation speed), and then an initial load is applied to the gas turbine. The initial load that is applied to the gas turbine is set in advance, and after the initial load is applied, the load of the gas turbine is controlled to gradually increase toward a target load as time elapses.

A load transition of the gas turbine after the initial load application is typically controlled to increase at a substantially constant change amount (that is, proportionally) with the elapse of time. Therefore, it takes time for the load of the gas turbine to reach the target load. In order to solve such problems, PTL 1 aims to shorten a startup time by making a change amount of a load at the time of startup of a gas turbine variable according to a load band.

### CITATION LIST

### Patent Literature

[PTL 1] Japanese Unexamined Patent Application Publication No. 2010-121598

### SUMMARY OF INVENTION

### Technical Problem

In PTL 1, the load change amount at the time of the startup of the gas turbine is variable according to the load band, and in particular, the startup control is performed such that the load change amount in a low load band is increased. Therefore, in PTL 1, although the startup time of the gas turbine can be temporarily shortened by having a large load change amount in the low load band, since the change in the load change amount according to the load band is realized by a single controller, there is a concern that the output of the gas turbine (in other words, the output of the generator connected to the gas turbine) may become unstable.

In order to shorten the startup time of the gas turbine, it is also conceivable to significantly change the applied amount of initial load. However, the applied amount of initial load is limited by an upper limit value from the viewpoint of appropriately maintaining the operation of the gas turbine, and there is a constraint that the applied amount of initial load cannot be set excessively.

At least one embodiment of the present disclosure has been made in view of the above-described circumstances, and an object of the present disclosure is to provide a gas turbine startup control device capable of completing startup of a gas turbine in a short time while stably maintaining an output of the gas turbine.

### Solution to Problem

In order to solve the above problems, according to at least one embodiment of the present disclosure, there is provided a gas turbine startup control device, which is a gas turbine control device including:
a fuel flow rate command value calculation unit configured to calculate a fuel flow rate command value by proportional integral control based on a deviation between a rotation speed of a gas turbine and a target rotation speed, or a deviation between an output of the gas turbine and a target output load; and
a fuel flow rate control unit configured to control a flow rate of fuel to the gas turbine based on the fuel flow rate command value,
in which the fuel flow rate command value calculation unit calculates the fuel flow rate command value such that the output of the gas turbine increases at a first change rate in a first output band, and calculates the fuel flow rate command value such that the output of the gas turbine increases at a second change rate smaller than the first change rate in a second output band, which is an output band higher than the first output band, and
an integral gain of the proportional integral control in the first output band is smaller than an integral gain of the proportional integral control in the second output band.

### Advantageous Effects of Invention

According to at least one embodiment of the present disclosure, it is possible to provide a gas turbine startup control device capable of completing startup of a gas turbine in a short time while stably maintaining an output of the gas turbine.

### BRIEF DESCRIPTION OF DRAWINGS

FIG. 1 is a diagram showing a schematic configuration of a single-shaft combined cycle power generation system according to an embodiment.

FIG. 2 is a block diagram showing a functional configuration of a gas turbine startup control device of FIG. 1.

FIG. 3 is a flowchart showing a startup control method according to an embodiment.

FIG. 4 is an example showing a transition of a generator output and a fuel flow rate command value after it is determined that a speed increase control is completed in step S101 of FIG. 3.

FIG. 5 is a comparative example of FIG. 4.

FIG. 6 is a comparative example showing a transition of a generator output and a fuel flow rate command value in the startup control of a typical gas turbine.

FIG. 7 is a block diagram showing a functional configuration of a first fuel flow rate command value calculation unit of FIG. 2.

FIG. 8 is a block diagram showing a functional configuration of a second fuel flow rate command value calculation unit of FIG. 2.

FIG. 9 is a diagram showing a transition of a fuel flow rate command value at the time of startup control corresponding to FIGS. 7 and 8.

FIG. 10 is a block diagram showing another example of a functional configuration of the fuel flow rate command value calculation unit of FIG. 2.

FIG. 11 is a block diagram showing an internal configuration of a proportional integral controller of FIG. 10.

FIG. 12 is an example of a function that defines a relationship between an integral component and the generator output of FIG. 11.

FIG. 13 is a modification example of FIG. 12.

### DESCRIPTION OF EMBODIMENTS

Hereinafter, some embodiments of the present invention will be described with reference to the accompanying drawings. Meanwhile, configurations described in the embodiments or shown in the drawings are not intended to limit the scope of the present invention, and are merely examples for description.

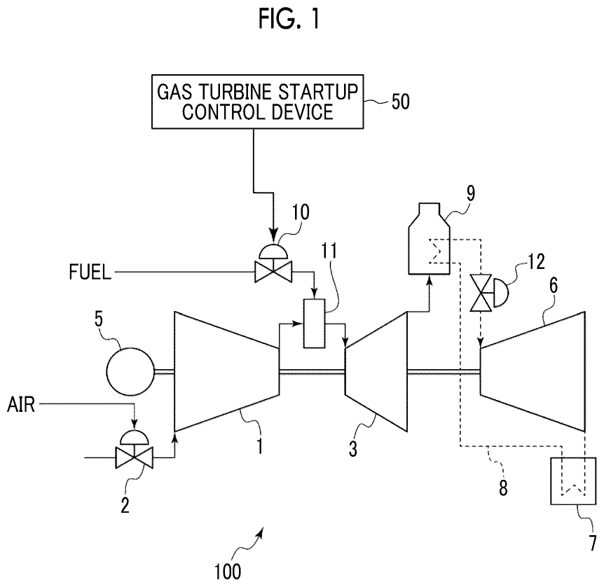

First, a single-shaft combined cycle power generation system 100 including a gas turbine 3, which is a control target of a gas turbine startup control device 50 according to at least one embodiment of the present disclosure, will be described with reference to FIG. 1. FIG. 1 is a diagram showing a schematic configuration of a single-shaft combined cycle power generation system 100 according to an embodiment.

The single-shaft combined cycle power generation system 100 includes a combustor 11 that supplies combustion gas to a gas turbine 3, a flow rate regulation valve 10 provided in a fuel channel that supplies fuel to the combustor 11, a gas turbine startup control device 50 that performs startup control of the gas turbine 3, a compressor 1, a condenser 7, a condensate pump 8, a heat recovery steam generator 9, and a steam regulation valve 12. A pipe for supplying air or the like to the compressor 1 is provided with an inlet guide vane regulation valve (IGV regulation valve) 2 for controlling an angle of an inlet guide vane for regulating the flow rate of a working fluid such as air. In addition, the gas turbine 3, a steam turbine 6, and a generator 5 are connected to one shaft.

In such a configuration, the compressed air compressed by the compressor 1 and the fuel of which the flow rate is regulated by the flow rate regulation valve 10 are supplied to the combustor 11, and these are mixed and combusted to generate a combustion gas. The combustion gas flows into the gas turbine 3 and serves as power for rotating the gas turbine 3. In this manner, the rotational force of the gas turbine 3 is transmitted to the generator 5, and the generator 5 generates power.

The combustion gas that has performed work in the gas turbine 3 is guided to the heat recovery steam generator 9 downstream thereof as an exhaust gas, and is released into the atmosphere through a chimney (not shown) or the like. The heat recovery steam generator 9 generates steam from a supplied water (condensate) from the condenser 7 by using the heat recovered from the exhaust gas. The steam passes through the steam regulation valve 12 and is guided to the steam turbine 6. The steam guided to the steam turbine 6 rotates the steam turbine 6. The rotational force of the steam turbine 6 is transmitted to the generator 5 and is used for power generation of the generator 5.

In the following description, the output of the generator 5 is handled as the output of the gas turbine 3 (that is, the output of the generator 5 is essentially synonymous with the output of the gas turbine 3).

The steam turbine 6 performs expansion work by using the steam supplied from the heat recovery steam generator 9 to drive the generator 5, and simultaneously supplies the steam that has completed the expansion work to the condenser 7 via a flow channel. The condenser 7 condenses the steam supplied from the steam turbine 6 and converts the steam into condensate. The condensate flows through the flow channel 8 by means of the condensate pump and is supplied to the heat recovery steam generator 9. This condensate is required when generating steam in the heat recovery steam generator 9.

The gas turbine startup control device 50 is a control unit that controls startup of the gas turbine 3, and is configured with, for example, a central processing unit (CPU), a random-access memory (RAM), a read-only memory (ROM), and a computer-readable storage medium. A series of processing for realizing various functions is stored in a storage medium or the like in the form of a program, as an example, and the CPU reads out the program to the RAM or the like, and executes processing for information processing and calculation, whereby various functions are realized. A form installed in advance in the ROM or other storage medium, a form provided in a state of being stored in a computer-readable storage medium, or a form of being delivered via wired or wireless communication means may be applied as the program. The computer-readable storage medium is a magnetic disk, a magneto-optical disk, a CD-ROM, a DVD-ROM, a semiconductor memory, or the like.

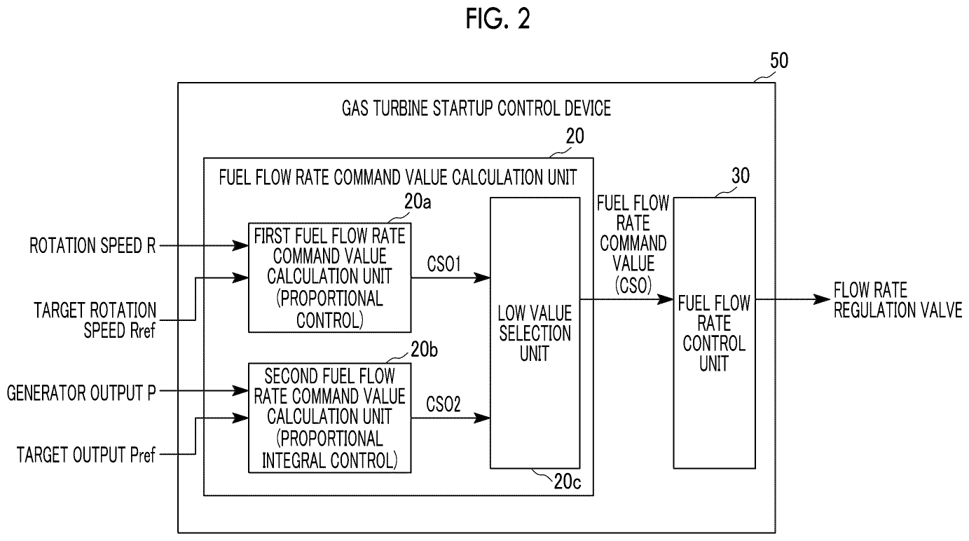

FIG. 2 is a block diagram showing a functional configuration of the gas turbine startup control device 50 of FIG. 1. The gas turbine startup control device 50 includes a fuel flow rate command value calculation unit 20 and a fuel flow rate control unit 30.

The fuel flow rate command value calculation unit 20 acquires a state quantity (a rotation speed R of the gas turbine 3, an output P of the generator 5, or the like) related to the operation state of the gas turbine 3 as an input signal, and outputs a fuel flow rate command value CSO obtained by calculation. In the present embodiment, the fuel flow rate command value calculation unit 20 is configured to calculate the fuel flow rate command value CSO by proportional integral control based on a deviation between the rotation speed R of the gas turbine 3 and a target rotation speed Rref, or a deviation between the output P of the gas turbine 3 and a target output Pref. In addition, the fuel flow rate control unit 30 is configured to control the fuel flow rate to the combustor 11 by receiving the fuel flow rate command value CSO from the fuel flow rate command value calculation unit 20 and controlling an opening degree of the flow rate regulation valve 10 based on the fuel flow rate command value CSO.

The fuel flow rate command value calculation unit 20 includes a first fuel flow rate command value calculation unit 20a, a second fuel flow rate command value calculation unit 20b, and a low value selection unit 20c. Among the input signals, the rotation speed R of the gas turbine 3 is input to the first fuel flow rate command value calculation unit 20a, and a first fuel flow rate command value CSO1, which is one candidate for the fuel flow rate command value CSO, is output. A target value of the rotation speed R (hereinafter, a “target rotation speed Rref”) is input to the first fuel flow rate command value calculation unit 20a, and the first fuel flow rate command value CSO1 is calculated based on a deviation between the rotation speed R and the target rotation speed Rref, as will be described later. As will be described later, the first fuel flow rate command value CSO1 is treated as a fuel flow rate command value CSO in a first output band.

Among the input signals, the generator output P is input to the second fuel flow rate command value calculation unit 20b, and a second fuel flow rate command value CSO2, which is one candidate for the fuel flow rate command value CSO, is output. A target value (hereinafter, referred to as a “target output Pref”) of the generator output P is input to the second fuel flow rate command value calculation unit 20b, and the second fuel flow rate command value CSO2 is calculated based on a deviation between the generator output P and the target output Pref, as will be described later. As will be described later, the second fuel flow rate command value CSO2 is treated as the fuel flow rate command value CSO in a second output band.

The first fuel flow rate command value CSO1 calculated by the first fuel flow rate command value calculation unit 20a and the second fuel flow rate command value CSO2 calculated by the second fuel flow rate command value calculation unit 20b are respectively input to the low value selection unit 20c. The low value selection unit 20c selects a smaller one of the first fuel flow rate command value CSO1 and the second fuel flow rate command value CSO2 as the fuel flow rate command value CSO, and outputs the fuel flow rate command value CSO to the fuel flow rate command value calculation unit 20.

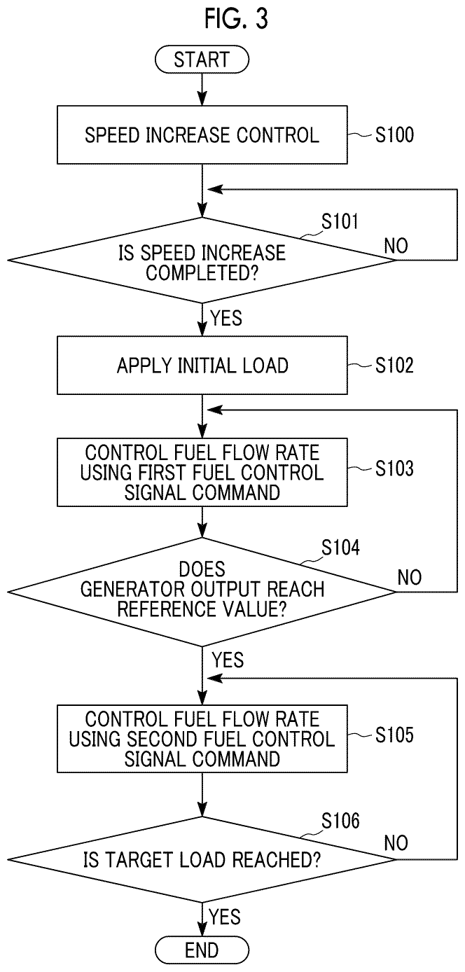

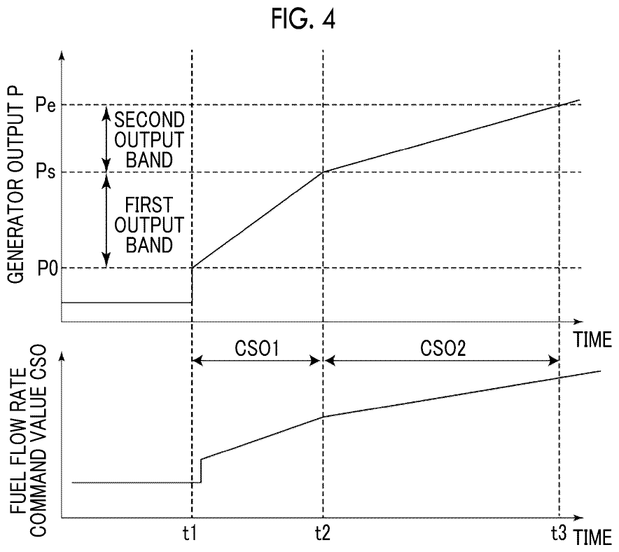

Next, a startup control method performed by the gas turbine startup control device 50 having the above configuration will be described. FIG. 3 is a flowchart showing a startup control method according to one embodiment, and FIG. 4 is an example showing a transition of a generator output P and a fuel flow rate command value CSO after it is determined that a speed increase control is completed in step S101 of FIG. 3.

First, the gas turbine startup control device 50 performs speed increase control on the gas turbine 3 in a stopped state in a no-load state (step S100). In the speed increase control, the gas turbine 3 is in a no-load state (that is, a state where the generator output P is zero) in which a load is not applied, and the rotation speed R of the gas turbine 3 in a stopped state is increased toward a rated rotation speed Rmax, which is a target rotation speed set in advance.

Subsequently, the gas turbine startup control device 50 determines whether or not the speed increase control in step S100 has been completed (step S101). In step S101, it is determined that the speed increase control is completed in a case where the rotation speed R of the gas turbine 3 reaches the rated rotation speed Rmax, which is the target rotation speed set in advance. When the speed increase control is completed (step S101: YES), the rotation speed R of the gas turbine 3 is controlled to maintain the rated rotation speed Rmax, which is the target rotation speed.

Subsequently, an initial load is applied to the gas turbine 3 in a no-load state in which the speed increase control is completed (step S102). The applied amount of the initial load applied in step S102 is set in advance, but can be set in consideration of the actual performance of the steam turbine 6 as an example. For example, in the steam turbine 6, in order to avoid a windage loss due to reverse power from the generator 5, it is necessary to secure a certain amount of load as the initial load. On the other hand, from the viewpoint of a constraint of an increase in thermal load due to a metal temperature mismatch, it is preferable that the initial load is equal to or less than a predetermined upper limit amount. The applied amount of the initial load can be appropriately set in consideration of such conditions.

In FIG. 4, an initial load is applied at a time t1, and the generator output Pis an initial output P0 corresponding to the initial load.

Subsequently, since the generator output P is in the first output band where the generator output P is relatively low after the initial load is applied, the gas turbine startup control device 50 controls the fuel flow rate using the first fuel flow rate command value CSO1 as the fuel flow rate command value CSO (step S103). At this time, as will be described in detail later, the first fuel flow rate command value CSO1 is set to be smaller than the second fuel flow rate command value CSO2, so that the low value selection unit 20c selects the first fuel flow rate command value CSO1 as the fuel flow rate command value CSO.

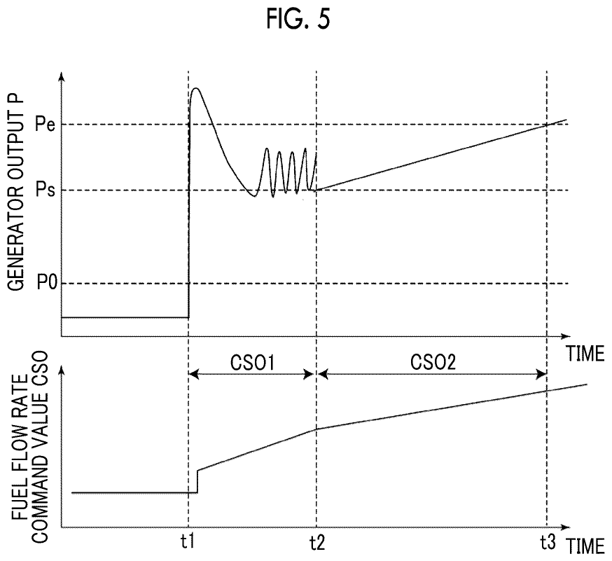

In step S103, the first fuel flow rate command value calculation unit 20a that calculates the first fuel flow rate command value CSO1 selected as the fuel flow rate command value CSO performs proportional control based on the deviation between the rotation speed R and the target rotation speed Rref to calculate the first fuel flow rate command value CSO1. In a case where the proportional integral control is adopted instead of the proportional control in the first fuel flow rate command value calculation unit 20a, the generator output P becomes unstable as in the comparative example shown in FIG. 5. Therefore, in the first fuel flow rate command value calculation unit 20a, the first fuel flow rate command value CSO1 is calculated by proportional control, so that stability can be ensured even when a change rate of the fuel flow rate command value CSO with respect to time is set to be large.

Subsequently, the gas turbine startup control device 50 determines whether or not the generator output P has reached a reference value Ps set in advance (step S104). In a case where the generator output P is less than the reference value Ps (step S104: NO), the process returns to step S103, and the increase in the generator output P by the first fuel flow rate command value CSO1 is continued.

On the other hand, in a case where the first output band is switched to the second output band because the generator output P reaches the reference value Ps (step S104: NO), the gas turbine startup control device 50 controls the fuel flow rate using the second fuel flow rate command value CSO2 as the fuel flow rate command value CSO (step S105). At this time, as will be described in detail later, the second fuel flow rate command value CSO2 is set to be smaller than the first fuel flow rate command value CSO 1, and thus the low value selection unit 20c selects the second fuel flow rate command value CSO2 as the fuel flow rate command value CSO.

In step S105, the second fuel flow rate command value calculation unit 20b that calculates the second fuel flow rate command value CSO2 selected as the fuel flow rate command value CSO calculates the second fuel flow rate command value CSO2 by proportional integral control based on the deviation between the generator output P and the target output Pref. In step S105, since the generator output P is sufficiently large by exceeding the reference value Ps, the second fuel flow rate command value calculation unit 20b can ensure stability even when the second fuel flow rate command value CSO2 is calculated by proportional integral control via proportional control.

Subsequently, the gas turbine startup control device 50 determines whether or not the generator output P has reached a target output Pe set in advance (step S106). In a case where the generator output P is less than the target output Pe (step S106: NO), the process returns to step S105, and the increase in the generator output P by the second fuel flow rate command value CSO2 is continued. On the other hand, in a case where the generator output P reaches the target output Pe (step S106: NO), the gas turbine startup control device 50 ends a series of startup control and transitions to a normal operation.

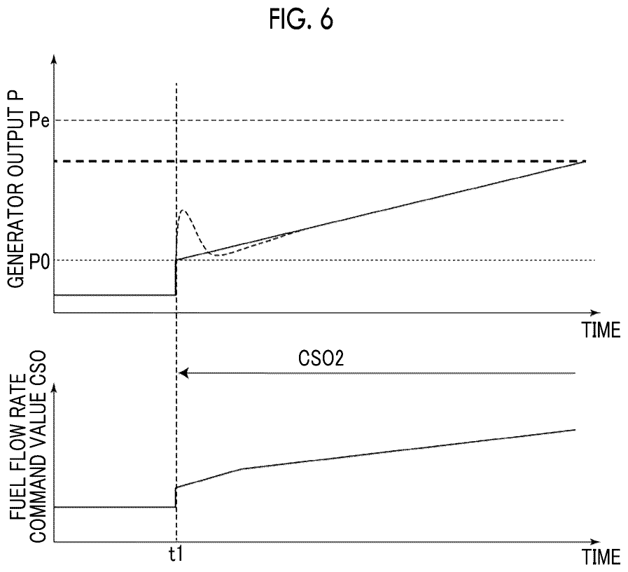

Here, FIG. 6 is a comparative example showing the transition of the generator output P and the fuel flow rate command value CSO in the startup control of the typical gas turbine 3. In the comparative example shown in FIG. 6, after the initial load is applied at the time t1, the startup control is performed by the fuel flow rate control in which the above-described second fuel flow rate command value CSO2 is set as the fuel flow rate command value CSO. That is, in this comparative example, the fuel control after the initial load is applied is performed only by the second fuel flow rate command value CSO2 in the full output band. In this case, if the change amount of the second fuel flow rate command value CSO2 with respect to time is excessively large, the control becomes unstable. Therefore, it is necessary to suppress the change amount of the fuel flow rate command value CSO to be relatively small. Therefore, there is a problem in that the startup time until the generator output P reaches the target output Pe becomes long.

In contrast, in the above-described embodiment, in the first output band corresponding to the time t1 to the time t2 at which the initial load is applied, the fuel flow rate control is performed by using the first fuel flow rate command value CSO1 as the fuel flow rate command value CSO. Since the first fuel flow rate command value CSO1 is calculated by proportional control in the first fuel flow rate command value calculation unit 20a, the control is unlikely to become unstable even if the change amount with respect to time increases. Therefore, as shown in FIG. 4, the change amount (first change amount) in the first output band between the time t1 and the time t2 is made larger than the change amount (second change amount) in the second output band after the time t2, so that the startup time until the generator output P reaches the target output can be effectively shortened.

In this way, a fuel flow rate command value SOC is calculated by the proportional integral control in accordance with the output band in the fuel flow rate command value calculation unit 20. In the above embodiment, in the first output band, a first fuel flow rate command value SOC1 calculated by the first fuel flow rate command value calculation unit 20a through proportional control is treated as the fuel flow rate command value SCO. Here, the proportional control is essentially equivalent to a case where an integral gain Ki is set to zero in the proportional integral control. Therefore, instead of the proportional control, the first fuel flow rate command value calculation unit 20a may calculate the first fuel flow rate command value SOC1 by using the proportional integral control having a non-zero integral gain Ki in a range smaller than the integral gain Ki in the proportional integral control when a second fuel flow rate command value SOC2 is calculated by the second fuel flow rate command value calculation unit 20b in the second output band (in other words, in the first output band, the first fuel flow rate command value SOC1 may be calculated by using the proportional integral control having the integral gain Ki smaller than the integral gain Ki in the second output band).

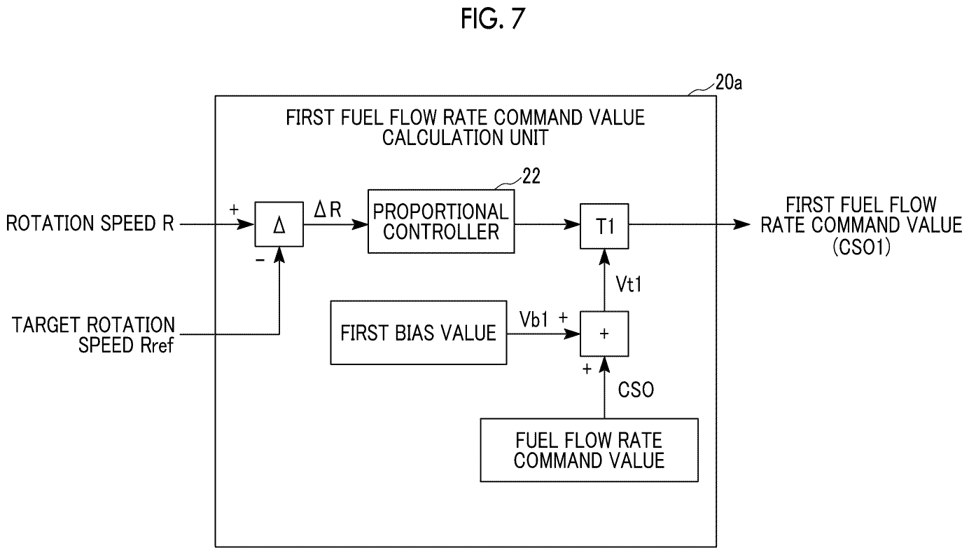

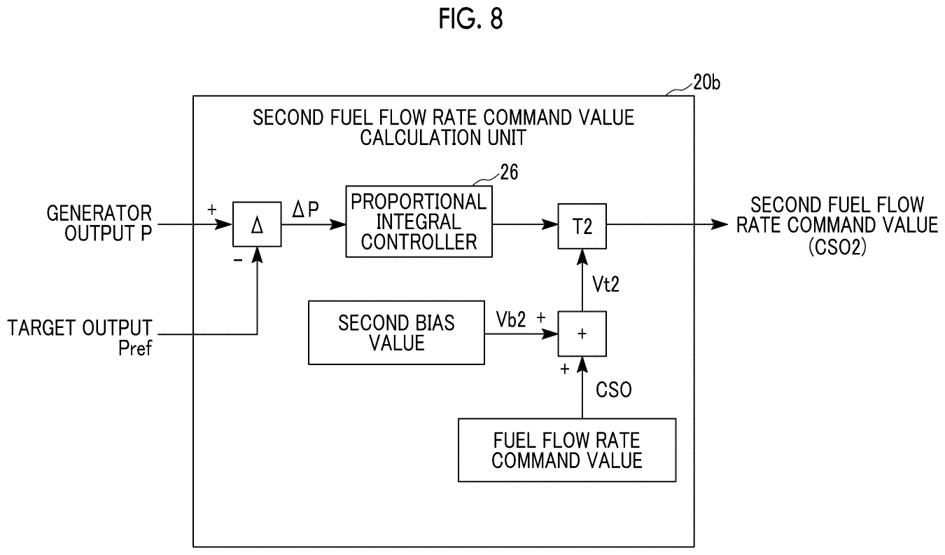

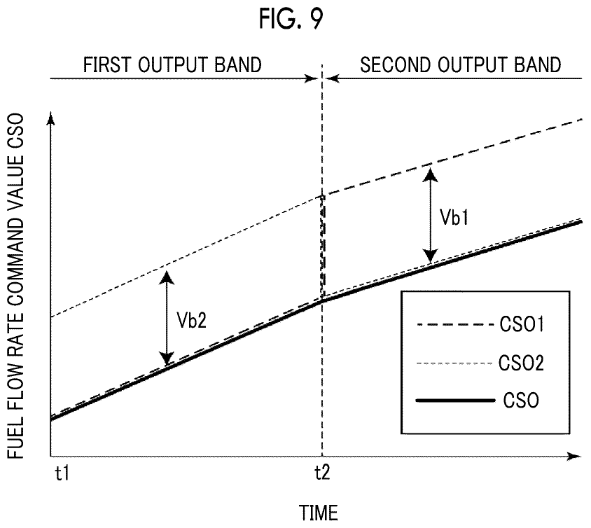

Next, the internal configurations of the first fuel flow rate command value calculation unit 20a and the second fuel flow rate command value calculation unit 20b will be described with reference to FIGS. 7 to 9. FIG. 7 is a block diagram showing a functional configuration of the first fuel flow rate command value calculation unit 20a of FIG. 2, FIG. 8 is a block diagram showing a functional configuration of the second fuel flow rate command value calculation unit 20b of FIG. 2, and FIG. 9 is a diagram showing a transition of the fuel flow rate command value CSO at the time of startup control corresponding to FIGS. 7 and 8.

As shown in FIG. 7, the rotation speed R, which is a state quantity relating to the operation state of the gas turbine 3, and the target rotation speed Rref corresponding to the rotation speed R are respectively input to the first fuel flow rate command value calculation unit 20a. A deviation AR between the rotation speed R and the target rotation speed Rref is input to a proportional controller 22. The proportional controller 22 outputs the first fuel flow rate command value CSO1 corresponding to the deviation ΔR.

In addition, the first fuel flow rate command value calculation unit 20a includes a switch T1 for switching the first fuel flow rate command value CSO1 output from the first fuel flow rate command value calculation unit 20a between the output value of the proportional controller 22 and a first tracking value Vt1. The first tracking value Vt1 is obtained by adding a first bias value Vb1 to the fuel flow rate command value CSO output from the fuel flow rate command value calculation unit 20.

The switch T1 is switched according to the switching state. Specifically, in a case where the generator output P is less than the reference value Ps as in a period between the time t1 and the time t2 in FIG. 4 and is in the first output band, the switch T1 is switched such that the first fuel flow rate command value CSO1 output from the proportional controller 22 is output as it is. On the other hand, in a case where the generator output P exceeds the reference value Ps and is in the second output band as in the time t2 or later in FIG. 4, the switch T1 is switched such that the first tracking value Vt1 is output.

As shown in FIG. 8, the generator output P, which is a state quantity related to the operation state of the gas turbine 3, and the target output Pref corresponding to the generator output P are respectively input to the second fuel flow rate command value calculation unit 20b. A deviation ΔP between the generator output P and the target output Pref is input to a proportional integral controller 26. The proportional integral controller 26 outputs the second fuel flow rate command value CSO2 corresponding to the deviation ΔP.

In addition, the second fuel flow rate command value calculation unit 20b includes a switch T2 for switching the second fuel flow rate command value CSO2 output from the second fuel flow rate command value calculation unit 20b between the output value of the proportional integral controller 26 and a second tracking value Vt2. The second tracking value Vt2 is obtained by adding a second bias value Vb2 to the fuel flow rate command value CSO output from the fuel flow rate command value calculation unit 20.

The switch T2 is switched according to the switching state. Specifically, in a case where the generator output P is less than the reference value Ps as in a period from the time t1 to the time t2 in FIG. 4 and is in the first output band, the switch T2 is switched such that the second tracking value Vt2 is output. On the other hand, in a case where the generator output P exceeds the reference value Ps as in the time t2 or later in FIG. 4 and the generator output P is in the second output band, the second fuel flow rate command value CSO2 output from the proportional integral controller 26 is switched to be output as it is.

As shown in FIG. 9, between the time t1 and the time t2 when the initial load is applied, the first fuel flow rate command value CSO1 is output from the first fuel flow rate command value calculation unit 20a, and the second tracking value Vt2 (=fuel flow rate command value CSO+second bias value Vb2) is output as the second fuel flow rate command value CSO2 from the second fuel flow rate command value calculation unit 20b. Therefore, between the time t1 and the time t2 in the first output band, the first fuel flow rate command value CSO1 is smaller than the second fuel flow rate command value CSO2. Therefore, the first fuel flow rate command value CSO1 is used as the fuel flow rate command value CSO.

After the time t2, the first tracking value Vt1 (=fuel flow rate command value CSO+first bias value Vb1) is output from the first fuel flow rate command value calculation unit 20a, and the second fuel flow rate command value CSO2 is output from the second fuel flow rate command value calculation unit 20b. Therefore, after the time t2 in the second output band, the second fuel flow rate command value CSO2 is smaller than the first fuel flow rate command value CSO1, and thus the second fuel flow rate command value CSO2 is used as the fuel flow rate command value CSO.

In addition, as illustrated in FIG. 9, at the time t2 when the first output band is switched to the second output band because the generator output P increases and reaches the reference value Ps, the second fuel flow rate command value CSO2 that is selected as a low value as the fuel flow rate command value CSO in the second output band is tracked to the most recent fuel flow rate command value CSO (in other words, the first fuel flow rate command value CSO1 that is selected as a low value in the first output band immediately before the switching to the second output band). In this manner, the fuel flow rate command value CSO is continuous before and after the time t2 when the output band is switched, so that the stability of control can be ensured.

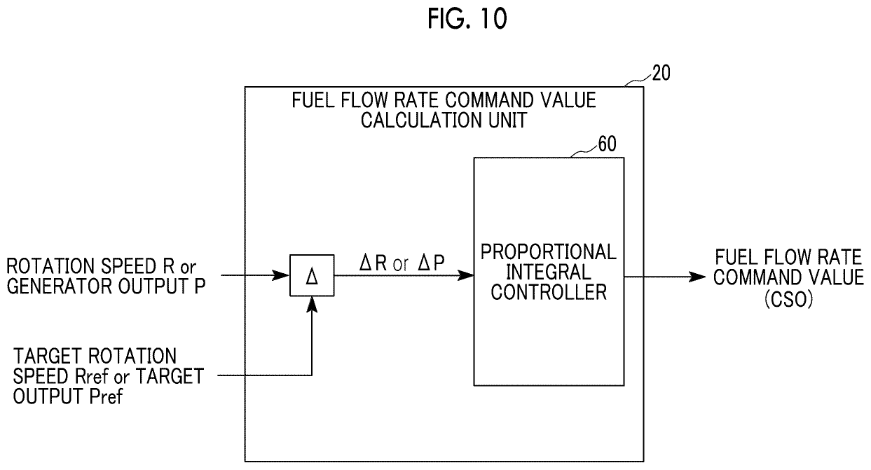

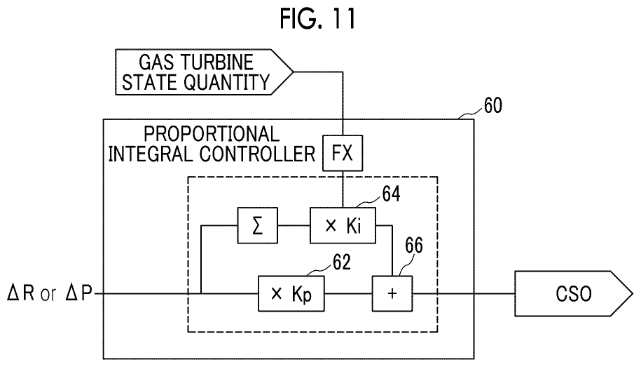

FIG. 10 is a block diagram showing another example of the functional configuration of the fuel flow rate command value calculation unit 20 of FIG. 2, and FIG. 11 is a block diagram showing the internal configuration of a proportional integral controller 60 of FIG. 10. In the embodiment described above with reference to FIGS. 2 to 9, the fuel flow rate command value calculation unit 20 has a configuration in which the fuel flow rate command value calculation unit 20 uses essentially two controllers (a proportional controller and a proportional integral controller) by treating either the first fuel flow rate command value CSO1 calculated by proportional control in the first fuel flow rate command value calculation unit 20a or the second fuel flow rate command value CSO2 calculated by proportional integral control in the second fuel flow rate command value calculation unit 20b as the fuel flow rate command value CSO. On the other hand, the embodiment shown in FIGS. 10 and 11 is different in that the fuel flow rate command value calculation unit 20 is configured to use a single proportional integral controller 60.

In the present embodiment, the fuel flow rate command value calculation unit 20 calculates the fuel flow rate command value CSO corresponding to the deviation between the gas turbine state quantity and the target value. The gas turbine state quantity is any parameter correlated with the output of the gas turbine 3, and includes, for example, the gas turbine output, the generator output, the fuel flow rate command value CSO, the intake flow rate, or the gas turbine chamber pressure. In the example shown in FIG. 10, as the gas turbine state quantity, the rotation speed R or the generator output P is input to the fuel flow rate command value calculation unit 20 as the state quantity relating to the operation state of the gas turbine 3. A deviation ΔR between the rotation speed R and a target rotation speed Rref input separately is calculated, and the deviation ΔR is input to the proportional integral controller 60. In addition, a deviation ΔP between the generator output P and a target output Pref input separately is calculated, and the deviation ΔP is also input to the proportional integral controller 60. The proportional integral controller 60 calculates the fuel flow rate command value CSO corresponding to the input deviation ΔR or ΔP, based on proportional integral control.

The proportional integral controller 60 is configured to perform proportional integral control for calculating the fuel flow rate command value CSO corresponding to the input gas turbine state quantity, and includes a proportional calculation unit 62 and an integration calculation unit 64. The proportional calculation unit 62 outputs a first calculation value by multiplying a predetermined proportional component (P component) by the deviation ΔR or ΔP input to the proportional integral controller 60. The integration calculation unit 64 integrates the error of the deviation ΔR or ΔP input to the proportional integral controller 60, and calculates the second calculation value by multiplying the integration result by the integral component (I component) corresponding to the integral gain Ki. The first calculation value and the second calculation value are added by an adder 66 and are output as the fuel flow rate command value CSO.

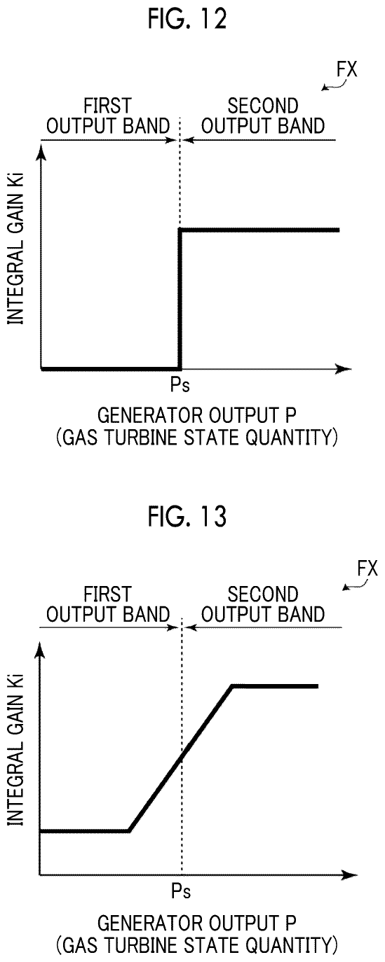

Here, the integral component Ki in the integration calculation unit 64 is variably set based on the gas turbine state quantity. The relationship between the gas turbine state quantity and the integral gain Ki is defined by a function FX. Here, FIG. 12 is an example of the function FX that defines a relationship between the integral gain Ki of FIG. 11 and the gas turbine state quantity. In a case where the function FX is in the first output band because the generator output P, which is an example of the gas turbine state quantity, is less than the reference value Ps, the integral gain Ki is set to zero. Accordingly, the proportional integral controller 60 functions essentially as a proportional controller. At this time, the proportional integral controller 60 calculates the first fuel flow rate command value CSO1 as the fuel flow rate command value CSO based on the input deviation ΔR, and a function equivalent to the first fuel flow rate command value calculation unit 20a illustrated in FIG. 2 is effectively realized.

On the other hand, in a case where the function FX is in the second output band because the generator output P, which is the gas turbine state quantity, is equal to or greater than the reference value Ps, the integral gain Ki is set to a finite value greater than zero based on the function FX. Accordingly, the proportional integral controller 60 functions essentially as a proportional integral controller. At this time, the proportional integral controller 60 calculates the second fuel flow rate command value CSO2 as the fuel flow rate command value based on the input deviation ΔP, and a function equivalent to the second fuel flow rate command value calculation unit 20b illustrated in FIG. 2 is effectively realized.

FIG. 13 is a modification example of FIG. 12. In the function FX in this modification example, the integral gain Ki is set to be small in a case where the generator output P is in the first output band but is sufficiently lower than the reference value Ps, and the integral gain Ki is set to be high in a case where the generator output P is in the second output band but is sufficiently higher than the reference value Ps. This point is the same as the function FX shown in FIG. 12. On the other hand, the integral gain Ki is set to gradually increase as the generator output P increases in a case where the generator output P is close to the reference value Ps, which is different from the function FX shown in FIG. 12. By determining the integral gain Ki as a function of such form, it is possible to reduce the deviation of the generator output P from the target load without destabilizing the control in a wide load band including a case where the generator output P is close to the reference value Ps, and to perform highly accurate output control.

In this way, in the present embodiment, by switching the integral gain Ki in the proportional integral controller 60 according to the gas turbine state quantity, it is possible to realize a configuration in which two controllers (a proportional controller and a proportional integral controller) are effectively used in a single proportional integral controller 60.

As described above, according to each of the above-described embodiments, it is possible to realize the gas turbine startup control device 50, the gas turbine startup control method, and the gas turbine startup control program capable of completing the startup of the gas turbine 3 in a short time.

In addition, it is possible to appropriately replace the components in the embodiment described above with well-known components within the scope which does not depart from the gist of the present disclosure, and the embodiments described above may be combined as appropriate.

For example, contents described in each of the above-described embodiments are understood as follows.
(1) A gas turbine startup control device according to an aspect is a gas turbine control device including:
a fuel flow rate command value calculation unit configured to calculate a fuel flow rate command value by proportional integral control based on a deviation between a rotation speed of a gas turbine and a target rotation speed, or a deviation between an output of the gas turbine and a target output load; and
a fuel flow rate control unit configured to control a flow rate of fuel to the gas turbine based on the fuel flow rate command value,
in which the fuel flow rate command value calculation unit calculates the fuel flow rate command value such that the output of the gas turbine increases at a first change rate in a first output band, and calculates the fuel flow rate command value such that the output of the gas turbine increases at a second change rate smaller than the first change rate in a second output band, which is an output band higher than the first output band, and
an integral gain of the proportional integral control in the first output band is smaller than an integral gain of the proportional integral control in the second output band.

According to the above aspect (1), the fuel flow rate control with respect to the gas turbine is performed based on the fuel flow rate command value calculated by the proportional integral control based on the deviation between the rotation speed of the gas turbine and the target rotation speed, or the deviation between the output of the gas turbine and the target output load. The fuel flow rate command value is calculated such that the change rate of the output of the gas turbine is different depending on the output band when the output of the gas turbine increases. Specifically, since the first change rate in the first output band, which is relatively low, is larger than the second change rate in the second output band, which is higher than the first output band, the increase in the output of the gas turbine can be completed more quickly than in a case where the output of the gas turbine is increased only by the second change rate, and the startup time of the gas turbine can be effectively shortened. In particular, the integral gain in the first output band is made smaller than the integral gain in the second output band, so that the operating state of the gas turbine can be effectively stabilized when the output increases.

The proportional integral control when calculating the fuel flow rate command value is a concept including proportional control (proportional control) corresponding to a case where the integral gain is zero, and proportional integral control (proportional integral control) in which the integral gain is non-zero, and further includes so-called proportional integral differential control in which the differential gain is non-zero.
(2) In another aspect, in the aspect of the above (1),
the fuel flow rate command value calculation unit includes
   a first fuel flow rate command value calculation unit for calculating a first fuel flow rate command value which is the fuel flow rate command value in the first output band, and
   a second fuel flow rate command value calculation unit for calculating a second fuel flow rate command value which is the fuel flow rate command value in the second output band.

According to the above aspect (2), the fuel flow rate command value in the first output band of the output of the gas turbine is calculated as the first fuel flow rate command value, and the fuel flow rate command value in the second output band of the output of the gas turbine is calculated as the second fuel flow rate command value.
(3) In another aspect, in the aspect of the above (2),
the first fuel flow rate command value calculation unit includes a proportional controller that calculates the first fuel flow rate command value based on the deviation between the rotation speed and the target rotation speed.

According to the above aspect (3), in a case where the output of the gas turbine is in the first output band, the first fuel flow rate command value calculated as the fuel flow rate command value is obtained as a calculation result of the proportional controller. In a case where a proportional integral controller is used, the stability of the followability of the output of the gas turbine with respect to the target output is lowered. However, the use of the proportional controller makes it possible to obtain stable followability.
(4) In another aspect, in the aspect of the above (2),
the second fuel flow rate command value calculation unit includes a proportional integral controller that calculates the second fuel flow rate command value based on the deviation between the output of the generator and the target output.

According to the above aspect (4), in a case where the output of the gas turbine is in the second output band, the second fuel flow rate command value calculated as the fuel flow rate command is obtained as a calculation result of the proportional integral controller.
(5) In another aspect, in the aspect of the above (2),
the gas turbine startup control device further includes a low value selection unit configured to select a smaller one of the first fuel flow rate command value and the second fuel flow rate command value as the fuel flow rate command value.

According to the above aspect (5), smaller one of the first fuel flow rate command value and the second fuel flow rate command value, calculated as candidates for the fuel flow rate command value, is selected as the fuel flow rate command value by the low value selection unit.
(6) In another aspect, in the aspect of the above (5),
in a case where the output of the gas turbine is in the first output band, the second fuel flow rate command value is a first tracking value obtained by adding a first bias value to the fuel flow rate command value.

According to the above aspect (6), in a case where the output of the gas turbine is in the first output band in which the output is relatively low, the second fuel flow rate command value is set to the first tracking value obtained by adding the first bias value to the fuel flow rate command value. Accordingly, since the second fuel flow rate command value is larger than the first fuel flow rate command value, the first fuel flow rate command value is appropriately selected as the fuel flow rate command value in the low value selection unit.
(7) In another aspect, in the aspect of the above (5),
in a case where the output of the gas turbine is in the second output band, the first fuel flow rate command value is a second tracking value obtained by adding a second bias value to the fuel flow rate command value.

According to the above aspect (7), in a case where the output of the gas turbine is in the second output band in which the output is relatively low, the first fuel flow rate command value is set to the second tracking value obtained by adding the second bias value to the fuel flow rate command value. Accordingly, since the first fuel flow rate command value is larger than the second fuel flow rate command value, the second fuel flow rate command value is appropriately selected as the fuel flow rate command value in the low value selection unit.
(8) In another aspect, in any one aspect of the above (1) to (7),
when the output of the gas turbine is switched from the first output band to the second output band, the second fuel flow rate command value is tracked to the fuel flow rate command value.

According to the above aspect (8), when the output of the gas turbine is increased and the first output band is switched to the second output band, the second fuel flow rate command value is tracked to the fuel flow rate command value. In this manner, the continuity of the fuel flow rate command value is ensured before and after the switching, and thus stable control can be performed.
(9) In another aspect, in the aspect of the above (1),
in the proportional integral control, the integral gain is variable based on a gas turbine state quantity correlated with the output of the gas turbine.

According to the above aspect (9), by using the proportional integral controller in which the integral gain is variable based on the gas turbine state quantity having a correlation with the output of the gas turbine, it is possible to calculate the fuel flow rate command value such that the output of the gas turbine increases at the first change rate or the second change rate according to the output band of the gas turbine with a single controller.
(10) In another aspect, in the aspect of the above (9),
in a case where the output of the gas turbine is in the first output band, the integral gain is set to zero.

According to the above aspect (10), in a case where the output of the gas turbine is in the first output band, the integral gain is set to zero, so that the proportional integral controller can be treated as a proportional controller.
(11) In another aspect, in any one aspect of the above (9) and (10),
the integral gain is calculated based on a function defining a relationship between the gas turbine state quantity and the integral gain.

According to the above aspect (11), the integral gain is calculated by using the function that defines the relationship between the gas turbine state quantity and the integral gain. In this manner, it is possible to calculate the integral gain according to the gas turbine state quantity correlated with the integral gain.
(12) In another aspect, in any one aspect of the above (1) to (11),
the first change rate is five times or more the second change rate.

According to the above aspect (12), by setting the first change rate to five times or more the second change rate, the startup time of the gas turbine can be effectively shortened.

### REFERENCE SIGNS LIST

1: compressor
3: gas turbine
5: generator
6: steam turbine
7: condenser
8: condensate pump
9: heat recovery steam generator
10: flow rate regulation valve
11: combustor
12: steam regulation valve
20: fuel flow rate command value calculation unit
20a: first fuel flow rate command value calculation unit
20b: second fuel flow rate command value calculation unit
20c: low value selection unit
30: fuel flow rate control unit
50: gas turbine startup control device
62: proportional calculation unit
64: integration calculation unit
66: adder
100: single-shaft combined cycle power generation system

1. A gas turbine control device comprising:
a fuel flow rate command value calculation unit configured to calculate a fuel flow rate command value by proportional integral control based on a deviation between a rotation speed of a gas turbine and a target rotation speed, or a deviation between an output of the gas turbine and a target output load; and
a fuel flow rate control unit configured to control a flow rate of fuel to the gas turbine based on the fuel flow rate command value,
wherein the fuel flow rate command value calculation unit calculates the fuel flow rate command value such that the output of the gas turbine increases at a first change rate in a first output band, and calculates the fuel flow rate command value such that the output of the gas turbine increases at a second change rate smaller than the first change rate in a second output band, which is an output band higher than the first output band, and
an integral gain of the proportional integral control in the first output band is smaller than an integral gain of the proportional integral control in the second output band.

2. The gas turbine control device according to claim 1,
wherein the fuel flow rate command value calculation unit includes
a first fuel flow rate command value calculation unit for calculating a first fuel flow rate command value which is the fuel flow rate command value in the first output band, and
a second fuel flow rate command value calculation unit for calculating a second fuel flow rate command value which is the fuel flow rate command value in the second output band.

3. The gas turbine startup control device according to claim 2,
wherein the first fuel flow rate command value calculation unit includes a proportional controller that calculates the first fuel flow rate command value based on the deviation between the rotation speed and the target rotation speed.

4. The gas turbine startup control device according to claim 2,
wherein the second fuel flow rate command value calculation unit includes a proportional integral controller that calculates the second fuel flow rate command value based on the deviation between the output of the gas turbine and the target output.

5. The gas turbine startup control device according to claim 2, further comprising:
a low value selection unit configured to select a smaller one of the first fuel flow rate command value and the second fuel flow rate command value as the fuel flow rate command value.

6. The gas turbine startup control device according to claim 5,
wherein, in a case where the output of the gas turbine is in the first output band, the second fuel flow rate command value is a first tracking value obtained by adding a first bias value to the fuel flow rate command value.

7. The gas turbine startup control device according to claim 5,
wherein, in a case where the output of the gas turbine is in the second output band, the first fuel flow rate command value is a second tracking value obtained by adding a second bias value to the fuel flow rate command value.

8. The gas turbine startup control device according to claim 1,
wherein when the output of the gas turbine is switched from the first output band to the second output band, the second fuel flow rate command value is tracked to the fuel flow rate command value.

9. The gas turbine startup control device according to claim 1,
wherein, in the proportional integral control, the integral gain is variable based on a gas turbine state quantity correlated with the output of the gas turbine.

10. The gas turbine startup control device according to claim 9,
wherein, in a case where the output of the gas turbine is in the first output band, the integral gain is set to zero.

11. The gas turbine startup control device according to claim 9,
wherein the integral gain is calculated based on a function defining a relationship between the gas turbine state quantity and the integral gain.

12. The gas turbine startup control device according to claim 1,
wherein the first change rate is five times or more the second change rate.
